(19) United States
(12) Patent Application Publication
(10) Pub. No.: US 2022/0328822 A1
(43) Pub. Date: Oct. 13, 2022

(54) POSITIVE ELECTRODE AND NONAQUEOUS ELECTROLYTE SECONDARY BATTERY COMPRISING SAME

(71) Applicant: Prime Planet Energy & Solutions, Inc., Tokyo (JP)

(72) Inventors: Shinya SUZUKI, Kobe-shi (JP); Akira TSUJIKO, Kobe-shi (JP)

(21) Appl. No.: 17/707,970

(22) Filed: Mar. 30, 2022

(30) Foreign Application Priority Data
Mar. 31, 2021 (JP) 2021-059556

(51) Int. Cl. H01M 4/525; H01M 4/36

(52) U.S. Cl. CPC H01M 4/525; H01M 4/366; H01M 2004/028

(57) ABSTRACT

The positive electrode is provided with a positive electrode current collector and a positive electrode active material layer that is supported on the positive electrode current collector. The positive electrode active material layer contains a positive electrode active material and a surfactant. The positive electrode active material contains a lithium composite oxide that has a nickel content, with respect to the metal atoms other than lithium, of at least 70 mol %. The positive electrode active material layer has a multilayer structure that includes at least two layers that have different mass percentages of the surfactant with respect to the total of the positive electrode active material and the surfactant. The mass percentage of the surfactant in a layer that has a larger mass percentage of surfactant, of the layers present in the multilayer structure is not less than 1.0 mass % and not more than 10 mass %.

### BACKGROUND OF THE INVENTION

### 1. Field of the Invention

The present disclosure relates to a positive electrode. The present disclosure also relates to a nonaqueous electrolyte secondary battery that includes this positive electrode. The present application claims priority to Japanese Patent Application No. 2021-059556 filed Mar. 31, 2021, the contents of which are incorporated in their entirety in this Specification by reference.

### 2. Description of the Related Art

In recent years, nonaqueous electrolyte secondary batteries such as lithium ion secondary batteries are suitably used as portable power sources in personal computers, mobile terminals and the like, and also as power sources for vehicle drive in, for instance, battery electric vehicles (BEV), hybrid electric vehicles (HEV) and plug-in hybrid electric vehicles (PHEV).

The positive electrodes of nonaqueous electrolyte secondary batteries generally have a structure in which a positive electrode active material layer, which contains a positive electrode active material, is supported on a positive electrode current collector. Art is already known wherein the ability of the nonaqueous electrolyte solution to impregnate into the positive electrode active material layer is enhanced by incorporating a surfactant into the positive electrode active material layer so as to improve the wettability of the positive electrode active material layer with the nonaqueous electrolyte solution (Japanese Translation of PCT Application No. 2009-526349, Japanese Patent Application Laid-open Nos. 2008-21415 and 2015-201309).

### SUMMARY OF THE INVENTION

However, as a result of intensive investigations, the present inventors have found a new problem in the art in which a surfactant is incorporated in the positive electrode active material layer, and the problem is that when a lithium composite oxide having a high nickel (Ni) content is used as the positive electrode active material, the surfactant degrades at high voltages, which results in gas generation.

An object of the present disclosure is therefore to provide a positive electrode having a positive electrode active material layer that contains a surfactant and a lithium composite oxide with a high nickel content, in which the positive electrode exhibits an excellent impregnating ability of the nonaqueous electrolyte solution into the positive electrode active material layer and exhibits a suppression of gas generation at high voltage.

The herein disclosed positive electrode is provided with a positive electrode current collector and a positive electrode active material layer that is supported on the positive electrode current collector. The positive electrode active material layer contains a positive electrode active material and a surfactant. The positive electrode active material contains a lithium composite oxide that has a nickel content of at least 70 mol % with respect to the metal atoms other than lithium. The positive electrode active material layer has a multilayer structure that contains at least two layers having different mass percentages of the surfactant with respect to the total of the positive electrode active material and the surfactant. The mass percentage of the surfactant in a layer that has a larger mass percentage of surfactant, of the layers present in the multilayer structure is not less than 1.0 mass % and not more than 10 mass %. This construction can provide a positive electrode having a positive electrode active material layer that contains a surfactant and a lithium composite oxide with a high nickel content, in which the positive electrode exhibits an excellent impregnating ability of the nonaqueous electrolyte solution into the positive electrode active material layer and exhibits a suppression of gas generation at high voltages.

In a desired aspect of the herein disclosed positive electrode, the mass percentage of the surfactant in a layer that has a smaller mass percentage of surfactant, of the layers present in the multilayer structure is not more than 0.5 mass %. This construction can achieve a greater suppression of gas generation.

In a desired aspect of the herein disclosed positive electrode, the ratio of the thickness of a layer having a larger mass percentage of surfactant to the thickness of a layer having a smaller mass percentage of surfactant is not less than 0.1 and not more than 0.5. This construction can achieve a greater suppression of gas generation.

In a desired aspect of the herein disclosed positive electrode, the mass percentage of the surfactant in a layer having a larger mass percentage of surfactant is not less than 1.0 mass % and not more than 5.0 mass %. This construction can achieve a greater suppression of gas generation.

In a desired aspect of the herein disclosed positive electrode, the surfactant is a nonionic surfactant. This construction can provide a greater suppression of gas generation.

In a desired aspect of the herein disclosed positive electrode, the coverage ratio of the positive electrode active material by the surfactant in a layer having a larger mass percentage of surfactant is not less than 5% and not more than 50%. This construction can achieve a greater suppression of gas generation.

In a desired aspect of the herein disclosed positive electrode, a layer having a larger mass percentage of surfactant contains a positive electrode active material in the form of single particles. This construction can achieve an even greater impregnating ability of the nonaqueous electrolyte solution into the positive electrode active material layer.

In another aspect, the herein disclosed nonaqueous electrolyte secondary battery is provided with a nonaqueous electrolyte solution, a negative electrode, and the positive electrode that has been described in the preceding. This construction can provide a nonaqueous electrolyte secondary battery that exhibits an excellent impregnating ability of the nonaqueous electrolyte solution into the positive electrode active material layer as well as a suppression of gas generation at high voltage.

### BRIEF DESCRIPTION OF THE DRAWINGS

FIG. 1 is a cross-sectional diagram that schematically illustrates the structure of a positive electrode according to a first embodiment of the present disclosure;

FIG. 2 is a cross-sectional diagram that schematically illustrates the structure of a positive electrode according to a second embodiment of the present disclosure;

FIG. 3 is a cross-sectional diagram that schematically illustrates the structure of a positive electrode according to a third embodiment of the present disclosure;

FIG. 4 is a cross-sectional diagram that schematically illustrates the internal structure of a lithium ion secondary battery according to an embodiment of the present disclosure; and

FIG. 5 is a schematic exploded diagram that illustrates the structure of the wound electrode assembly of a lithium ion secondary battery according to an embodiment of the present disclosure.

### DESCRIPTION OF THE PREFERRED EMBODIMENTS

Embodiments according to the present disclosure are described in the following with reference to the figures. Matters required for the execution of the present disclosure but not described in this Specification can be understood as design matters for the individual skilled in the art based on the conventional art in the pertinent field. The present disclosure can be implemented based on the contents disclosed in this Specification and the common general technical knowledge in the pertinent field. In the figures referenced in the following, members and positions that exercise the same function are assigned the same reference sign in the description. The dimensional relationships (length, width, thickness, and so forth) in the individual figures do not reflect actual dimensional relationships.

The term “secondary battery” in this Specification denotes a power storage device in general capable of being charged and discharged repeatedly, and includes so-called storage batteries and power storage elements such as electrical double layer capacitors. In this Specification, the term “lithium ion secondary battery” denotes a secondary battery that utilizes lithium ions as charge carriers, and in which charging and discharge are realized as a result of movement of charge with lithium ions, between the positive electrode and the negative electrode.

### First Embodiment

A first embodiment is illustrated in FIG. 1 as an example of the herein disclosed positive electrode. The positive electrode 50 according to this first embodiment is provided, as shown in the figure, with a positive electrode current collector 52 and a positive electrode active material layer 54 that is supported on the positive electrode current collector 52. As shown in the example in the figure, the positive electrode active material layer 54 is disposed on both sides of the positive electrode current collector 52, but it may be provided on a single side. The positive electrode active material layer 54 desirably is provided on both sides of the positive electrode current collector 52.

As shown in the example in the figure, the positive electrode 50 may have, at least at one edge, a positive electrode active material layer-free region 52a where the positive electrode active material layer 54 has not been formed and the positive electrode current collector 52 is exposed as a result. The positive electrode active material layer-free region 52a functions as a current collection section (particularly a current collection tab).

A sheet or foil of a metal, e.g., aluminum, nickel, titanium, stainless steel, and so forth, can be used as the positive electrode current collector 52, and the use of aluminum foil is desired. When aluminum foil is used as the positive electrode current collector 52, its thickness is not particularly limited, but can be from 5 μm to 35 μm and is desirably from 7 μm to 20 μm.

As shown in the figure, the positive electrode active material layer 54 has a multilayer structure that is provided with a layer 54A positioned on the side of the positive electrode current collector 52 and with a layer 54B positioned on the surface layer side. The layer 54A and the layer 54B are shown only in one positive electrode active material layer 54, but in the first embodiment, two positive electrode active material layers 54 have the multilayer structure. However, the multilayer structure that contains the layer 54A and the layer 54B may be present in only the one positive electrode active material layer 54.

The positive electrode active material layer 54 (i.e., each of the layer 54A and the layer 54B) contains, as the positive electrode active material, a lithium composite oxide that has a nickel content of at least 70 mol % with respect to the metal atoms other than lithium (also referred to in the following as a “high Ni content lithium composite oxide”).

There are no particular limitations on the type of the high Ni content lithium composite oxide as long as the Ni content is at least 70 mol % with respect to the metal atoms other than lithium. The high Ni content lithium composite oxide desirably has a layered rock salt type crystalline structure. Such a lithium composite oxide can be exemplified by lithium nickel cobalt manganese composite oxides, lithium nickel cobalt aluminum composite oxides, and so forth.

In this Specification, “lithium nickel cobalt manganese composite oxides” is a term that encompasses oxides in which the constituent elements are Li, Ni, Co, Mn, and O and also encompasses oxides that contain one or two or more additional elements other than the preceding. These additional elements can be exemplified by, e.g., transition metal elements and representative metal elements, e.g., Mg, Ba, Sr, Ca, Al, Ti, V, Cr, Y, Zr, Nb, Mo, Hf, Ta, W, Na, K, Fe, Cu, Zn, Sn, and so forth. The additional elements may also be a semimetal element such as B, C, Si, P, and so forth, or a nonmetal element such as S, F, Cl, Br, I, and so forth. This also applies to the aforementioned lithium nickel cobalt aluminum composite oxides and so forth.

The high Ni content lithium composite oxide is desirably a lithium nickel cobalt manganese composite oxide because this can impart various advantageous characteristics to the lithium ion secondary battery 100. The lithium nickel cobalt manganese composite oxide desirably has the composition represented by the following formula (I).

Li₁₊ₓNi_{y}Co_{z}Mn_{(1-y-z)}M_{α}O_{2-β}Q_{β} (I)

The x, y, z, α, and β in formula (I) respectively satisfy −0.3≤x≤0.3, 0.7≤y≤0.95, 0.02≤z≤0.28, 0≤α≤0.1, and 0≤β≤0.5. M is at least one element selected from the group consisting of Al, Zr, B, Mg, Fe, Cu, Zn, Sn, Na, K, Ba, Sr, Ca, W, Mo, Nb, Ti, and Si. Q is at least one element selected from the group consisting of F, Cl, and Br. x desirably satisfies 0≤x≤0.3, more desirably satisfies 0≤x≤0.15, and still more desirably is 0. From the standpoint of the energy density, y desirably satisfies 0.75≤y≤0.95. z desirably satisfies 0.03≤z≤0.22. α desirably satisfies 0≤α≤0.05 and is more desirably 0. β desirably satisfies 0≤β≤0.1 and is more desirably 0.

The positive electrode active material layer 54 may contain, within a range in which the effects of the present disclosure are not impaired, a positive electrode active material other than the high Ni content lithium composite oxide. A single species alone may be used for the positive electrode active material, or a combination of two or more species may be used. The layer 54A and the layer 54B may contain the same positive electrode active material or may contain different positive electrode active materials.

The content of the positive electrode active material is not particularly limited, but is desirably at least 70 mass % in the positive electrode active material layer 54 (i.e., with respect to the total mass of the positive electrode active material layer) and is more desirably at least 80 mass % and still more desirably at least 85 mass %.

The average particle diameter (median diameter, D50) of the positive electrode active material is not particularly limited, but, for example, is not less than 0.05 μm and not more than 25 μm, desirably not less than 0.5 μm and not more than 23 μm, and more desirably not less than 3 μm and not more than 22 μm. The average particle diameter (median diameter, D50) of the positive electrode active material can be determined, for example, using a laser diffraction/scattering method.

The positive electrode active material layer 54 contains a surfactant. This surfactant may be a known surfactant conventionally used in positive electrode active material layers or may be a surfactant having properties at least equivalent thereto. Specifically, a cationic surfactant, anionic surfactant, amphoteric surfactant, nonionic surfactant, and so forth may be used as the surfactant. A single species thereof may be used by itself or a mixture of two or more species may be used.

The cationic surfactant can be exemplified by mono-/di-long chain alkyl quaternary ammonium salts such as alkyltrimethylammonium chloride and dialkyldimethylammonium chloride, and by alkylamine salts.

The anionic surfactant can be exemplified by alkylbenzenesulfonate, alkyl sulfate, alkyl ether sulfate, alkenyl ether sulfate, alkenyl sulfate, α-olefinsulfonate, α-sulfofatty acids and their ester salts, alkanesulfonate, saturated fatty acid salts, unsaturated fatty acid salts, alkyl ether carboxylate, alkenyl ether carboxylate, amino acid-type surfactants, N-acylamino acid-type surfactants, alkyl phosphate esters and their salts, alkenyl phosphate esters and their salts, and alkyl sulfosuccinate.

The amphoteric surfactant can be exemplified by carboxyl-type amphoteric surfactants and sulfobetaine-type amphoteric surfactants.

The nonionic surfactant can be exemplified by polyoxyethylene alkyl ethers such polyethylene glycol dimethyl ether, polyoxyethylene lauryl ether, polyoxyethylene cetyl ether, polyoxyethylene stearyl ether, polyoxyethylene oleyl ether, and polyoxyethylene higher alkyl ethers; polyoxyethylene alkylaryl ethers such as polyoxyethylene nonylphenyl ether; polyoxyethylene sorbitan fatty acid esters such as polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, and polyoxyethylene sorbitan trioleate; sucrose fatty acid esters; polyoxyethylene sorbitol fatty acid esters such as polyoxyethylene sorbitol tetraoleate; polyoxyethylene fatty acid esters such as polyethylene glycol monolaurate, polyethylene glycol monostearate, polyethylene glycol distearate, and polyethylene glycol monooleate; polyoxyethylene alkyl amines; polyoxyethylene hydrogenated castor oil; block copolymers of ethylene oxide and propylene oxide; sorbitan fatty acid esters such as sorbitan monolaurate, sorbitan monomyristate, sorbitan monopalmitate, sorbitan monostearate, sorbitan tristearate, sorbitan monooleate, sorbitan trioleate, sorbitan sesquioleate, and sorbitan distearate; glycerol fatty acid esters such as glycerol monostearate, glycerol monooleate, diglycerol monooleate, and self-emulsifying glycerol monostearate; and alkylalkanol amides.

Nonionic surfactants are desired for the surfactant because they impart a particularly high impregnating ability of the nonaqueous electrolyte solution into the positive electrode active material layer 54 and achieve a particularly small amount of gas generation. Polyoxyethylene-type surfactants (i.e., surfactants that contain a polyoxyethylene unit) are desired for the nonionic surfactant, and polyoxyethylene alkyl ethers are more desired.

The mode of existence of the surfactant in the positive electrode active material layer 54 is not particularly limited, but the surfactant is desirably present while coating the positive electrode active material. In this case, the coverage ratio of the positive electrode active material by the surfactant is desirably not less than 5% and not more than 50% and is more desirably not less than 10% and not more than 30%. For example, the coverage ratio can be calculated using the spectral intensity provided by performing a measurement on the surfactant-coated positive electrode active material using x-ray photoelectron spectroscopy (XPS). Alternatively, the coverage ratio can be calculated based on the percentage of exposed surface of the positive electrode active material when the element distribution of the surfactant-coated positive electrode active material is observed using an electron microscope.

The positive electrode active material can be coated by the surfactant using known methods (dry methods, wet methods). In dry methods, for example, the positive electrode active material can be coated with surfactant by mixing the surfactant and the positive electrode active material using, e.g., a high-speed stirrer. In wet methods, for example, the positive electrode active material can be coated with the surfactant by adding and mixing the surfactant into a positive electrode mixture slurry for forming the positive electrode active material layer 54, then applying this positive electrode mixture slurry onto a positive electrode current collector 52, and drying.

The positive electrode active material layer 54 may contain components other than the positive electrode active material and surfactant. Examples of these components are lithium phosphate (Li₃PO₄), a conductive material, a binder, and so forth.

The content of lithium phosphate in the positive electrode active material layer 54 is not particularly limited, but is desirably not less than 1 mass % and not more than 15 mass % and is more desirably not less than 2 mass % and not more than 12 mass %.

Carbon black such as acetylene black (AB) as well as other carbon materials (e.g., graphite) can be favorably used as the conductive material. The content of the conductive material in the positive electrode active material layer 54 is not particularly limited, but, for example, is from 0.1 mass % to 20 mass % and is desirably from 1 mass % to 15 mass % and more desirably from 2 mass % to 10 mass %.

For example, polyvinylidene fluoride (PVdF) and so forth can be used as the binder. The content of the binder in the positive electrode active material layer 54 is not particularly limited, but, for example, is from 0.5 mass % to 15 mass % and is desirably from 1 mass % to 10 mass % and is more desirably from 1.5 mass % to 8 mass %.

The layer 54A and the layer 54B in the positive electrode active material layer 54 have different mass percentages of surfactant with respect to the total of the positive electrode active material and surfactant (in the following, the mass percentage of surfactant with respect to the total of the positive electrode active material and surfactant is also referred to as the “surfactant mass percentage (S)” or simply the “mass percentage (S)”). One of the layers thus has a larger surfactant mass percentage (S). In this embodiment, the layer 54B has a larger surfactant mass percentage (S) than the layer 54A. The surfactant mass percentage (S) is not less than 1.0 mass % and not more than 10 mass % in the layer 54B having the larger surfactant mass percentage (S).

Thus, in the present embodiment, the positive electrode active material layer 54 is configured as a multilayer structure and the surfactant is unevenly distributed so that one layer has larger surfactant content. In addition, the amount of surfactant in the surfactant-rich layer is specified. As a consequence, the impregnating ability of the electrolyte solution is raised by providing a layer that forms a flow path for penetration of the nonaqueous electrolyte solution within the positive electrode active material layer 54, while at the same time gas generation at high voltage can be suppressed due to a reduction in the amount of surfactant in the overall positive electrode active material layer 54.

In terms of achieving additional reductions in gas generation, the surfactant mass percentage (S) in the layer 54B with the larger surfactant mass percentage (S) is desirably not less than 1.0 mass % and not more than 5.0 mass %.

The mass percentage (S) in the layer 54A is not particularly limited as long as it is smaller than the mass percentage (S) in the layer 54B. The mass percentage (S) in the layer 54A is desirably not more than half (i.e., not more than 50%) of the mass percentage (S) in the layer 54B and is more desirably not more than 20% of the mass percentage (S) in the layer 54B. The mass percentage (S) in the layer 54A may be 0 mass %. The mass percentage (S) in the layer 54A desirably is less than 1.0 mass %, more desirably not more than 0.5 mass %, and still more desirably not more than 0.2 mass %.

The surfactant mass percentage (S) can be determined, for example, by carrying out thermogravimetric and simultaneous differential thermal analysis (TG-DTA measurement) under a nitrogen atmosphere.

The ratio (layer 54B/layer 54A) of the thickness of the layer 54B with the larger surfactant mass percentage (S) to the thickness of the layer 54A with the smaller surfactant mass percentage (S) is not particularly limited, but viewed in terms of achieving further reductions in gas generation, is desirably not less than 0.1 and not more than 1.0 and is more desirably not less than 0.1 and not more than 0.5.

The overall thickness of the positive electrode active material layer 54 (i.e., the total thickness of the layer 54A and the layer 54B in the multilayer structure) is not particularly limited, but, for example, is from 10 μm to 300 μm and is desirably from 20 μm to 200 μm.

Positive electrode active materials generally take the form of secondary particles formed by the aggregation of primary particles. However, the layer 54B having the larger surfactant mass percentage (S) desirably contains a positive electrode active material in the form of single particles. This provides an even higher impregnating ability of the nonaqueous electrolyte solution into the positive electrode active material layer 54. This is thought to be due to the formation in the layer 54B of a fine network of permeation pathways for the nonaqueous electrolyte solution and an improvement in the impregnation rate of the nonaqueous electrolyte solution due to capillary phenomena.

Here, the term “single particle” is a particle produced by the growth of a single crystal nucleus and thus is a monocrystalline particle that does not contain a crystal grain boundary. That a particle is a monocrystal can be confirmed, for example, by analysis of the electron beam diffraction image provided using a transmission electron microscope (TEM).

The single particles have the property of being resistant to aggregation and a single particle by itself constitutes a positive electrode active material particle, but single particles may also aggregate to form a positive electrode active material particle. However, when single particles aggregate to form a positive electrode active material particle, the number of aggregated single particles is from 2 to 10. Thus, one positive electrode active material particle is constituted of from 1 to 10 single particles, and one positive electrode active material particle can be constituted of from 1 to 5 single particles, or can be constituted of from 1 to 3 single particles, or can be constituted of 1 single particle. The number of single particles in one positive electrode active material particle can be determined by observation using a scanning electron microscope (SEM) at a magnification of 10,000× to 30,000×.

These single particles are different from the secondary particles formed by the aggregation of many (specifically 11 or more) fine particles (primary particles) and from polycrystalline particles composed of a plurality of crystal grains. The single-particulate positive electrode active material can be produced according to known methods (for example, molten salt methods) for obtaining monocrystalline particles.

In addition, the single particles are generally larger than the primary particles for the case in which the primary particles constituting the secondary particles are monocrystals. The single particles are resistant to aggregation as a consequence. The largest diameter of a single particle may be at least 0.5 μm, or may be larger than 1 μm, or may be larger than 2 μm, or may be from 3 μm to 7 μm. The average largest diameter of the single particles may be from 3 μm to 7 μm. The largest diameter of a single particle can be determined from the SEM image of the single particle, as the distance between the two points, the points residing on the contour line of the single particle, that are separated by the greatest distance. This SEM image may be a two-dimensional projected image of the single particle or may be a cross-sectional image. The average largest diameter of the single particles can be determined from the SEM image as the average value of the largest diameter for at least 100 single particles selected at random.

The shape of the single particles is not particularly limited and may be spherical, columnar, plate shaped, or irregular.

From the standpoint of achieving a further suppression of gas generation, the layer 54B having the larger surfactant mass percentage (S) contains desirably at least 80 mass % and more desirably at least 90 mass % of the surfactant present in the positive electrode active material layer as a whole.

In this first embodiment, the layer 54B having the larger surfactant mass percentage (S) is located to the surface layer side of the positive electrode active material layer 54. In this case, the nonaqueous electrolyte solution that has penetrated from the interface between the separator and the outer surface of the positive electrode active material layer 54 can diffuse into the entire positive electrode active material layer 54 using the layer 54B on the surface layer side as a flow path. A particularly high impregnating ability of the nonaqueous electrolyte solution into the positive electrode active material layer 54 is provided as a result.

However, the position of the layer having the larger surfactant mass percentage (S) in the multilayer structure of the positive electrode active material layer 54 is not limited to this. A second embodiment of the herein disclosed positive electrode is thus described in the following.

### Second Embodiment

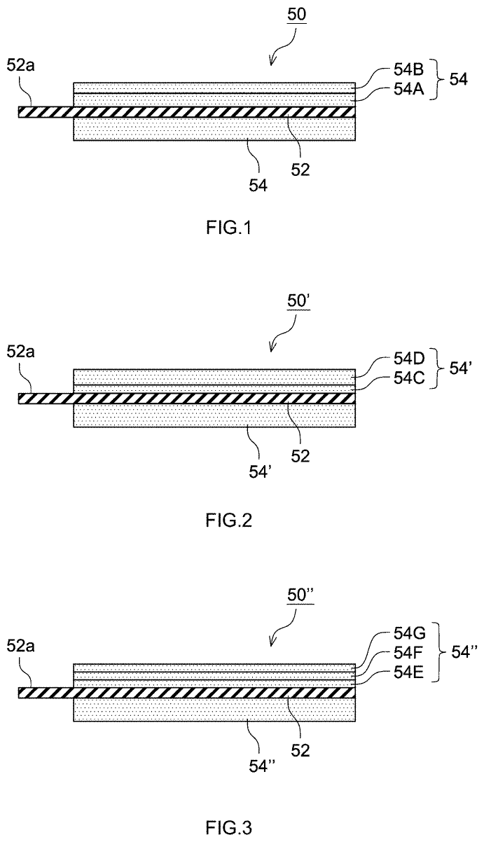

The second embodiment of the herein disclosed positive electrode is explained using FIG. 2. The positive electrode active material layer 54′ in the positive electrode 50′ shown in FIG. 2 has a multilayer structure provided with a layer 54C positioned on the side of the positive electrode current collector 52 and a layer 54D positioned on the surface layer side.

In this second embodiment, the layer 54C located on the side of the positive electrode current collector 52 has the larger surfactant mass percentage (S), and thus the layer 54C corresponds to the layer 54B in the first embodiment and the layer 54D corresponds to the layer 54A in the first embodiment. That is, the second embodiment is an embodiment in which the positions in the first embodiment of the layer 54B having the larger surfactant mass percentage (S) and the layer 54A having the smaller surfactant mass percentage (S) have been switched.

A greater suppression of gas generation can be achieved when the layer 54C having the larger surfactant mass percentage (S) is thusly disposed on the side of the positive electrode current collector 52 of the positive electrode active material layer 54′. This is due to the following: the surface layer region of the positive electrode active material layer 54′, which faces the negative electrode, has a greater reaction load and the surfactant is thus more readily degraded at high voltage, and the amount of surfactant undergoing degradation can be reduced by locating the layer 54C having the larger surfactant mass percentage (S) on the side of the positive electrode current collector 52 of the positive electrode active material layer 54′ (i.e., by locating the layer 54D having the smaller surfactant mass percentage (S) on the surface layer side of the positive electrode active material layer 54′).

### Third Embodiment

The positive electrode active material layer of the herein disclosed positive electrode may have a multilayer structure that has three or more layers. A third embodiment of the herein disclosed positive electrode will be explained using FIG. 3. The positive electrode active material layer 54″ in the positive electrode 50″ shown in FIG. 3 has a multilayer structure that is provided with a layer 54E located on the side of the positive electrode current collector 52, a layer 54F located in the center, and a layer 54G located on the surface layer side.

In the third embodiment, the surfactant mass percentage (S) is largest in the layer 54F located in the center, which corresponds to the layer 54B in the first embodiment. On the other hand, the surfactant mass percentages (S) of the layer 54E located on the side of the positive electrode current collector 52 and the layer 54G located on the surface layer side correspond to the layer 54A of the first embodiment.

When, as in the example in the figure, the surfactant mass percentage (S) is largest in an intermediate layer (the layer 54F in the example given in the figure) that resides at some distance from the outer surface and from the positive electrode current collector 52 of the positive electrode active material layer 54, a further suppression of gas generation can be achieved for the same reason as in the second embodiment. In addition, because the amount of the surfactant present in the vicinity of the positive electrode current collector 52 is smaller, increases in the interfacial resistance between the positive electrode active material layer 54 and the positive electrode current collector 52 can be inhibited.

It should be noted that when the positive electrode active material layer has a multilayer structure having three or more layers, a “layer having a larger mass percentage (S) of surfactant” indicates the “layer having the largest mass percentage (S) of surfactant”.

It should be noted that when the positive electrode active material layer has a multilayer structure having three of more layers, a layer having a larger mass percentage (S) of surfactant may be positioned on the surface layer side or may be positioned on the side of the positive electrode current collector 52.

### Other Embodiments

The distribution of the surfactant in each layer of the multilayer structure of the positive electrode active material layer in the herein disclosed positive electrode may not be uniform. There may thus be a prescribed concentration distribution in each layer of the multilayer structure of the positive electrode active material layer. Thus, for example, in another embodiment, the surfactant may be distributed so as to provide a surfactant concentration that declines from the outer surface of the positive electrode active material layer toward the positive electrode current collector; the surfactant mass percentage may be made different between a region (upper layer) extending from the outer surface to 33% of the thickness of the positive electrode active material layer and a region (lower layer) extending from the current collector to 67% of the thickness of the positive electrode active material layer; and the surfactant mass percentage in the upper layer, which has a large surfactant mass percentage, may be not less than 1.0 mass % and not more than 10 mass %.

The positive electrode constituted as described in the preceding provides an excellent impregnating ability of the nonaqueous electrolyte solution into the positive electrode active material layer and provides a suppression of gas generation. The positive electrode constituted as described in the preceding can be used for the positive electrode of a secondary battery according to a known method. The herein disclosed positive electrode is thus suitably used for a secondary battery. This secondary battery may be an all-solid-state battery, but is desirably a nonaqueous electrolyte secondary battery due to the excellent impregnability of the nonaqueous electrolyte solution into the positive electrode active material layer.

[Nonaqueous Electrolyte Secondary Battery]

In another aspect, the herein disclosed nonaqueous electrolyte secondary battery is provided with a nonaqueous electrolyte solution, a negative electrode, and the positive electrode described above.

One embodiment of the herein disclosed nonaqueous electrolyte secondary battery is described in detail in the following using, as an example, a flat rectangular lithium ion secondary battery having a flat wound electrode assembly and a flat battery case. However, this should not be construed as limiting the herein disclosed nonaqueous electrolyte secondary battery to what is described for this embodiment.

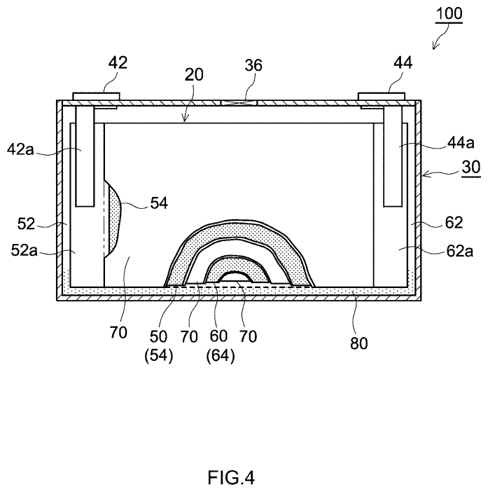

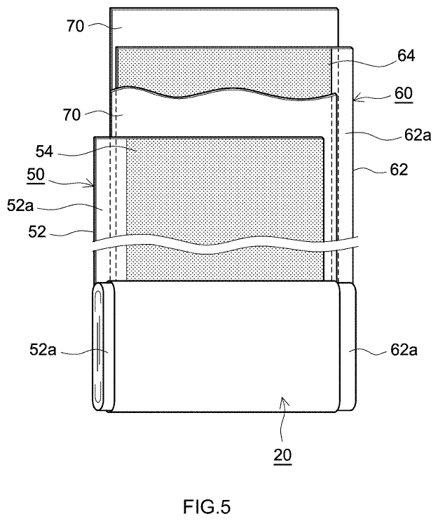

The lithium ion secondary battery 100 shown in FIG. 4 is a sealed battery fabricated by housing a flat wound electrode assembly 20 and a nonaqueous electrolyte solution 80 in a flat rectangular battery case (i.e., an outer container) 30. The following are disposed in the battery case 30: a positive electrode terminal 42 and a negative electrode terminal 44 for making external connections, and a thin-walled safety valve 36 set to release the internal pressure in the battery case 30 when the internal pressure rises to or above a predetermined level. An injection port (not shown) for injecting the nonaqueous electrolyte solution 80 is also disposed in the battery case 30. The positive electrode terminal 42 is electrically connected to a positive electrode current collector plate 42a. The negative electrode terminal 44 is electrically connected to a negative electrode current collector plate 44a. A lightweight metal material having a good thermal conductivity, e.g., aluminum, is used as the material of the battery case 30. The amount of the nonaqueous electrolyte solution 80 is not accurately depicted in FIG. 4.

As shown in FIG. 4 and FIG. 5, the wound electrode assembly 20 has a configuration in which a positive electrode sheet 50 and a negative electrode sheet 60 are stacked together with two continuous strip-shaped separator sheets 70 interposed therebetween, and are wound in the length direction. The positive electrode sheet 50 has a structure in which a positive electrode active material layer 54 is formed along the length direction on one side or both sides (both sides in this instance) of a continuous strip-shaped positive electrode current collector 52. The negative electrode sheet 60 has a structure in which a negative electrode active material layer 64 is formed along the length direction on one side or both sides (both sides in this instance) of a continuous strip-shaped negative electrode current collector 62. A positive electrode active material layer-free region 52a (that is, a region where the positive electrode active material layer 54 is not formed and the positive electrode current collector 52 is thereby exposed) and a negative electrode active material layer-free region 62a (that is, a region where the negative electrode active material layer 64 is not formed and the negative electrode current collector 62 is thereby exposed) are formed so as to extend to the outside from the two edges in the direction of the winding axis (that is, the sheet width direction perpendicular to the aforementioned length direction) of the wound electrode assembly 20. A positive electrode current collector plate 42a and a negative electrode current collector plate 44a are joined to the positive electrode active material layer-free region 52a and the negative electrode active material layer-free region 62a, respectively.

The positive electrode described hereinabove is used for the positive electrode sheet 50.

A sheet or foil of a metal, e.g., copper, nickel, titanium, stainless steel, and so forth, can be used as the negative electrode current collector 62 that constitutes the negative electrode sheet 60, and the use of copper foil is desired. When copper foil is used as the negative electrode current collector 62, its thickness is not particularly limited, but can be from 5 μm to 35 μm and is desirably from 7 μm to 20 μm.

Negative electrode active materials known for use in lithium ion secondary batteries can be used for the negative electrode active material; for example, carbon materials such as graphite, hard carbon, and soft carbon can be used. The graphite may be natural graphite or artificial graphite or may be an amorphous carbon-coated graphite in the form of graphite coated with an amorphous carbon material.

The content of the negative electrode active material in the negative electrode active material layer is not particularly limited, but is desirably at least 90 mass % and is more desirably at least 95 mass %.

The negative electrode active material layer 64 may contain components other than the negative electrode active material, for example, a binder, a thickener, and so forth.

The following, for example, can be used as the binder: styrene-butadiene rubber (SBR) and modified products thereof, acrylonitrile-butadiene rubber and modified products thereof, acrylic rubber and modified products thereof, and fluororubbers. SBR is desired among the preceding. The content of the binder in the negative electrode active material layer 64 is not particularly limited, but is desirably from 0.1 mass % to 8 mass % and is more desirably from 0.2 mass % to 3 mass %.

The following, for example, can be used as the thickener: cellulosic polymers, such as carboxymethyl cellulose (CMC), methyl cellulose (MC), cellulose acetate phthalate (CAP), and hydroxypropyl methyl cellulose (HPMC); and polyvinyl alcohol (PVA). CMC is desired among the preceding. The content of the thickener in the negative electrode active material layer 64 is not particularly limited, but is desirably from 0.3 mass % to 3 mass % and is more desirably from 0.4 mass % to 2 mass %.

The thickness of the negative electrode active material layer 64 is not particularly limited, but, for example, is from 10 μm to 300 μm and is desirably from 20 μm to 200 μm.

The separator 70 can be exemplified by a porous sheet (film) composed of a resin, for example, polyethylene (PE), polypropylene (PP), polyester, cellulose, polyamide, and so forth. This porous sheet may have a single-layer structure or may have a laminated structure of two or more layers (for example, a tri-layer structure in which a PP layer is laminated on both sides of a PE layer). A heat-resistant layer (HRL) may be disposed on the surface of the separator 70.

The thickness of the separator 70 is not particularly limited, but, for example, is from 5 μm to 50 μm and is desirably from 10 μm to 30 μm.

The nonaqueous electrolyte solution 80 typically contains a nonaqueous solvent and an electrolyte salt (also known as a supporting salt). The various organic solvents such as carbonates, ethers, esters, nitriles, sulfones, and lactones that are used in the electrolyte solutions of ordinary lithium ion secondary batteries can be used without particular limitation as the nonaqueous solvent. The carbonates are desired among the preceding and can be specifically exemplified by ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluorodimethyl carbonate (TFDMC). A single such nonaqueous solvent may be used by itself or a suitable combination of two or more may be used.

For example, a lithium salt such as LiPF₆, LiBF₄, and lithium bis(fluorosulfonyl)imide (LiFSI) can be used as the electrolyte salt, and LiPF₆ is desired among the preceding. The concentration of the electrolyte salt is not particularly limited, but is desirably from 0.7 mol/L to 1.3 mol/L.

As long as the effects of the present disclosure are not significantly impaired, the nonaqueous electrolyte solution 80 may contain components other than the components described in the preceding, for example, various additives such as film-forming agents, e.g., oxalate complexes; gas generators such as biphenyl (BP) and cyclohexylbenzene (CHB); thickeners; and so forth.

The nonaqueous electrolyte solution 80 readily impregnates into the positive electrode active material layer 54 in the lithium ion secondary battery 100 constituted as described in the preceding. An excellent productivity is thus obtained during production of the lithium ion secondary battery 100 because the nonaqueous electrolyte solution 80 introduced into the battery case 30 rapidly impregnates into the electrode assembly 20. In addition, when the lithium ion secondary battery 100 is subjected to repeated charge/discharge, the nonaqueous electrolyte solution 80 is squeezed out from the electrode assembly 20 accompanying the expansion/shrinkage of the active material, but return of the squeezed-out nonaqueous electrolyte solution 80 into the electrode assembly 20 is facilitated. Thus, substantial reductions in the amount of the nonaqueous electrolyte solution 80 within the electrode assembly 20 during repeated charge/discharge of the lithium ion secondary battery 100 are suppressed and thus the cycle characteristics are also excellent. Gas generation at high voltage caused by surfactant degradation in the positive electrode 50 is also suppressed.

The lithium ion secondary battery 100 can be used in a variety of applications. An advantageous application is as a drive power source mounted in a vehicle such as a battery electric vehicle (BEV), hybrid electric vehicle (HEV), and plug-in hybrid electric vehicle (PHEV). In addition, the lithium ion secondary battery 100 can be used as a storage battery for a small-scale power storage device and so forth. The lithium ion secondary battery 100 may also be used in the form of a battery pack typically resulting from connection of a plurality of the lithium ion secondary batteries 100 in series and/or in parallel.

A rectangular lithium ion secondary battery 100 provided with a flat wound electrode assembly 20 has been described as an example. However, the herein disclosed lithium ion secondary battery may also be constructed as a lithium ion secondary battery having a stacked-type electrode assembly (i.e., an electrode assembly in which a plurality of positive electrodes are stacked in alternation with a plurality of negative electrodes). The herein disclosed nonaqueous electrolyte secondary battery may also be constructed in the form of, for example, a cylindrical lithium ion secondary battery, a laminate-cased lithium ion secondary battery, a coin lithium ion secondary battery, and so forth.

Moreover, nonaqueous electrolyte secondary batteries other than lithium ion secondary batteries may also be fabricated according to known methods using the positive electrode described in the preceding.

Examples in accordance with the present disclosure are described below, but this is not intended to limit the present disclosure to the description in these examples.

### Example 1

A surfactant-coated active material (also referred to in the following as the “first active material”) was obtained by mixing the following at a mass ratio of 99:1 using a high-speed stirrer: a lithium nickel manganese cobalt composite oxide (LiNi_{0.8}Co_{0.1}Mn_{0.1}O₂; NCM811) in the form of secondary particles, as the positive electrode active material; polyethylene glycol dimethyl ether, as surfactant. A surfactant-coated active material (also referred to in the following as the “second active material”) was also obtained by mixing the following at a mass ratio of 99.5:0.5 using a high-speed stirrer:a lithium nickel manganese cobalt composite oxide (LiNi_{0.8}Co_{0.1}Mn_{0.1}O₂) in the form of secondary particles, as the positive electrode active material; polyethylene glycol dimethyl ether (PEGDME), as surfactant.

The first active material, acetylene black (AB) as a conductive material, and polyvinylidene fluoride (PVDF) as a binder were mixed at a mass ratio of first conductive material:AB:PVDF=97.5:1.5:1.0, and a suitable amount of N-methyl-2-pyrrolidone (NMP) was added to the resulting mixture to prepare a first positive electrode mixture slurry. In addition, the second active material, acetylene black (AB) as a conductive material, and polyvinylidene fluoride (PVDF) as a binder were mixed at a mass ratio of second conductive material:AB:PVDF=97.5:1.5:1.0, and a suitable amount of N-methyl-2-pyrrolidone (NMP) was added to the resulting mixture to prepare a second positive electrode mixture slurry.

The second positive electrode mixture slurry was applied and dried on both sides of a positive electrode current collector made of aluminum foil. The first positive electrode mixture slurry was then applied and dried on the dried coating from the second positive electrode mixture slurry. The ratio of the coating thickness of the first positive electrode mixture slurry to the coating thickness of the second positive electrode mixture slurry was made 0.5 in this operation. The coating film was then subjected to roll pressing using a rolling roller to produce a positive electrode sheet. After the roll pressing, the ratio in the positive electrode active material layer of the thickness of the layer formed by the first positive electrode mixture slurry to the thickness of the layer formed by the second positive electrode mixture slurry was the same 0.5 as the aforementioned coating thickness ratio.

Graphite (C) as the negative electrode active material, styrene-butadiene rubber (SBR) as a binder, and carboxymethyl cellulose (CMC) as a thickener were mixed in deionized water at a mass ratio of C:SBR:CMC=97.5:1.0:1.5 to prepare a slurry for forming a negative electrode active material layer. This slurry for forming a negative electrode active material layer was applied on copper foil. This was followed by drying and roll pressing to a prescribed thickness to fabricate a negative electrode sheet.

A porous polyolefin sheet having a PP/PE/PE tri-layer structure was prepared as a separator. The positive electrode sheet and the negative electrode sheet were stacked with the separator interposed therebetween to construct a stacked electrode assembly.

Electrode terminals were attached to the electrode assembly and this was inserted into an aluminum laminate film case followed by welding and then injection of a nonaqueous electrolyte solution. For the nonaqueous electrolyte solution, a solution in which LiPF₆ is dissolved at a concentration of 1.0 mol/L in a mixed solvent containing ethylene carbonate (EC) and dimethyl carbonate (DMC) at a volume ratio of 1:1 was used. The laminate case was then sealed to obtain a lithium ion secondary battery for evaluation of Example 1.

### Examples 2, 3, 5, and 6 and Comparative Examples 1 and 2

Lithium ion secondary batteries for evaluation of Example 2, Example 3, Example 5, Example 6, Comparative Example 1, and Comparative Example 2 were produced in the same manner as in Example 1, except changing the following to the values given in Table 1: the mass percentage (mass %) of surfactant with respect to the total of the surfactant and positive electrode active material, in the preparation of the first active material; and the mass percentage (mass %) of surfactant with respect to the total of the surfactant and positive electrode active material, in the preparation of the second active material.

### Example 4

A lithium ion secondary battery for evaluation of Example 4 was produced in the same manner as in Example 3, except applying the second positive electrode mixture slurry after applying the first positive electrode mixture slurry.

### Comparative Example 3

A surfactant-coated active material (first active material) was obtained by mixing the following at a mass ratio of 90:10 using a high-speed stirrer: a lithium nickel manganese cobalt composite oxide (LiNi_{0.8}Co_{0.1}Mn_{0.1}O₂) in the form of secondary particles, as the positive electrode active material; polyethylene glycol dimethyl ether, as surfactant. Using this, a first positive electrode mixture slurry was produced in a manner similar to Example 1. A positive electrode was fabricated in a manner similar to in Example 1, using only this first positive electrode mixture slurry. When this was done, the coating thickness of the first positive electrode mixture slurry was adjusted so as to provide a thickness of the positive electrode active material layer that was the same as in Example 1. A lithium ion secondary battery for evaluation of Comparative Example 3 was produced in the same manner as in Example 1, except using this positive electrode.

### Reference Example 1

A lithium ion secondary battery for evaluation of Reference Example 1 was produced in the same manner as in Comparative Example 3, except using, as the positive electrode active material, LiNi_{0.6}Co_{0.2}Mn_{0.2}O₂ (NCM622) in the form of secondary particles in place of the LiNi_{0.8}Co_{0.1}Mn_{0.1}O₂ (NCM811) in the form of secondary particles.

### Comparative Example 4

A lithium ion secondary battery for evaluation of Comparative Example 4 was produced in the same manner as in Comparative Example 3, except changing the mass ratio between the positive electrode active material and the surfactant to 99.8:0.2.

### Examples 7 to 9

Lithium ion secondary batteries for evaluation of Example 7, Example 8, and Example 9 were produced in the same manner as in Example 5, except changing the coating thicknesses of the first positive electrode mixture slurry and the second positive electrode mixture slurry and thereby changing, to the values given in Table 1, the ratio of the thickness of the layer formed by the first positive electrode mixture slurry to the thickness of the layer formed by the second positive electrode mixture slurry.

### Examples 10 and 11

Lithium ion secondary batteries for evaluation of Example 10 and Example 11 were produced in the same manner as in Example 5, except changing the coverage ratio by the surfactant of the first active material used in the first positive electrode mixture slurry, to the values given in Table 1.

### Example 12

A lithium ion secondary battery for evaluation of Example 12 was produced in the same manner as in Example 5, except changing the surfactant to alkyltrimethylammonium chloride (ATMAC).

### Example 13

A lithium ion secondary battery for evaluation of Example 13 was produced in the same manner as in Example 5, except using, as the positive electrode active material, LiNi_{0.8}Co_{0.1}Mn_{0.1}O₂ in the form of single particles in place of the LiNi_{0.8}Co_{0.1}Mn_{0.1}O₂ in the form of secondary particles.

<Evaluation of the Amount of Gas Generation>

The volume of each of the lithium ion secondary batteries for evaluation was determined by the Archimedes method using Fluorinert as the solvent. This volume was designated as an initial volume. Each of the lithium ion secondary batteries for evaluation was then charged to 4.3 V in a 25° C. environment and was left to stand for 5 days in a 45° C. environment. The volume of each lithium ion secondary battery for evaluation was then determined by the Archimedes method using Fluorinert as the solvent. The difference (mL) between the post-charging volume and the initial volume was determined and this was designated as the amount of gas generation. The results are given in Table 1.

<Evaluation of the Impregnability of the Electrolyte Solution>

For each of the positive electrodes fabricated in the preceding test examples, a positive electrode sample was prepared by cutting the positive electrode to dimensions of 5 cm×20 cm. The lower 3 cm of this positive electrode was perpendicularly dipped in the nonaqueous electrolyte solution that was used in the preceding test example, and the rate of infiltration (cm/h) of the electrolyte solution into the positive electrode active material layer was measured. The status of infiltration of the electrolyte solution into the positive electrode active material layer was determined from the change in color of the positive electrode active material layer when infiltrated by the electrolyte solution. The results are given in Table 1.

TABLE 1

| | | | | | surfactant | | | |
|---|---|---|---|---|---|---|---|---|
| | | | | | coverage | layer with larger | | |
| | | | | | ratio (%) for | surfactant mass | | |
| | type of | | | | layer with | percentage/layer | | |
| | positive | | | | larger | with smaller | amount of | |
| | electrode | | surfactant mass percentage | | surfactant | surfactant mass | gas | infiltration |
| | active | type of | upper layer | lower layer | mass | percentage, | production | rate |
| | material | surfactant | (mass %) | (mass %) | percentage | thickness ratio | (mL) | (cm/h) |
| Example 1 | NCM811 | PEGDME | 1.0 | 0.5 | 5 | 0.5 | 2.7 | 1.6 |
| Example 2 | NCM811 | PEGDME | 5.0 | 0.5 | 35 | 0.5 | 3.8 | 2.4 |
| Example 3 | NCM811 | PEGDME | 10.0 | 0.5 | 50 | 0.5 | 4.3 | 3.5 |
| Example 4 | NCM811 | PEGDME | 0.5 | 10.0 | 50 | 0.5 | 4.0 | 3.2 |
| Comparative | NCM811 | PEGDME | 15.0 | 0.5 | 60 | 0.5 | 6.5 | 3.6 |
| Example 1 | | | | | | | | |
| Comparative | NCM811 | PEGDME | 0.5 | 0.0 | 3 | 0.5 | 2.2 | 0.5 |
| Example 2 | | | | | | | | |
| Comparative | NCM811 | PEGDME | 10.0 (monolayer) | | — | — | 12.3 | 3.9 |
| Example 3 | | | | | | | | |
| Reference | NCM622 | PEGDME | 10.0 (monolayer) | | — | — | 2.1 | 3.8 |
| Example 1 | | | | | | | | |
| Example 5 | NCM811 | PEGDME | 5.0 | 0.2 | 35 | 0.5 | 3.4 | 2.3 |
| Example 6 | NCM811 | PEGDME | 5.0 | 1.0 | 35 | 0.5 | 4.5 | 2.4 |
| Comparative | NCM811 | PEGDME | 0.2 (monolayer) | | — | — | 2.1 | 0.4 |
| Example 4 | | | | | | | | |
| Example 7 | NCM811 | PEGDME | 5.0 | 0.2 | 35 | 0.1 | 2.9 | 1.8 |
| Example 8 | NCM811 | PEGDME | 5.0 | 0.2 | 35 | 0.3 | 3.3 | 2.2 |
| Example 9 | NCM811 | PEGDME | 5.0 | 0.2 | 35 | 0.7 | 5.4 | 2.4 |
| Example 10 | NCM811 | PEGDME | 5.0 | 0.2 | 15 | 0.5 | 3.0 | 2.1 |
| Example 11 | NCM811 | PEGDME | 5.0 | 0.2 | 25 | 0.5 | 3.2 | 2.2 |
| Example 12 | NCM811 | ATMAC | 5.0 | 0.2 | 25 | 0.5 | 4.8 | 1.6 |
| Example 13 | NCM811 | PEGDME | 5.0 | 0.2 | 15 | 0.5 | 3.6 | 3.2 |
| | (single | | | | | | | |
| | particle) | | | | | | | |

First, from a comparison of Comparative Example 3 with Reference Example 1, it can be understood that the problem of gas generation at high voltage is a characteristic problem that occurs when the lithium composite oxide has a high Ni content (particularly 70 mol % or more). From a comparison of the individual examples with the individual comparative examples, it can be understood that an excellent impregnating ability of the nonaqueous electrolyte solution into the positive electrode active material layer and a suppression of gas generation are achieved when the positive electrode active material layer has a multilayer structure that includes at least two layers having different mass percentages of the surfactant with respect to the total of the positive electrode active material and surfactant, and the mass percentage of the surfactant is not less than 1.0 mass % and not more than 10 mass % in a layer that, of the layers present in the multilayer structure, has a larger surfactant mass percentage.

Concrete examples of the present disclosure have been explained in detail above, but the examples are merely illustrative in nature, and are not meant to limit the scope of the claims in any way. The art set forth in the claims encompasses various alterations and modifications of the concrete examples illustrated above.

What is claimed is:

1. A positive electrode comprising a positive electrode current collector and a positive electrode active material layer that is supported on the positive electrode current collector, wherein:
the positive electrode active material layer contains a positive electrode active material and a surfactant;
the positive electrode active material includes a lithium composite oxide that has a nickel content of at least 70 mol % with respect to the metal atoms other than lithium;
the positive electrode active material layer has a multilayer structure that includes at least two layers having different mass percentages of the surfactant with respect to the total of the positive electrode active material and the surfactant; and
the mass percentage of the surfactant in a layer that has a larger mass percentage of surfactant, of the layers present in the multilayer structure is not less than 1.0 mass % and not more than 10 mass %.

2. The positive electrode according to claim 1, wherein the mass percentage of the surfactant in a layer that has a smaller mass percentage of surfactant, of the layers present in the multilayer structure is not more than 0.5 mass %.

3. The positive electrode according to claim 1, wherein the ratio of the thickness of a layer having a larger mass percentage of surfactant to the thickness of a layer having a smaller mass percentage of surfactant is not less than 0.1 and not more than 0.5.

4. The positive electrode according to claim 1, wherein the mass percentage of the surfactant in a layer having a larger mass percentage of surfactant is not less than 1.0 mass % and not more than 5.0 mass %.

5. The positive electrode according to claim 1, wherein the surfactant is a nonionic surfactant.

6. The positive electrode according to claim 1, wherein the coverage ratio of the positive electrode active material by the surfactant in a layer having a larger mass percentage of surfactant is not less than 5% and not more than 50%.

7. The positive electrode according to claim 1, wherein a layer having a larger mass percentage of surfactant contains a positive electrode active material in the form of single particles.

8. A nonaqueous electrolyte secondary battery comprising:
a positive electrode according to claim 1;
a negative electrode; and
a nonaqueous electrolyte solution.
